(19) United States
(12) Patent Application Publication
(10) Pub. No.: US 2024/0327437 A1
(43) Pub. Date: Oct. 3, 2024

(54) DE NOVO Synthesis of Cyclocreatine and Subsequent Conversion to Cyclocreatine Phosphate Via a Continuous Flow Reactor (CFR) System

(71) Applicant: Nour Heart, Inc., Vienna, VA (US)

(72) Inventors: Salwa Elgebaly, Vienna, VA (US); Robert Todd, Grafton, WI (US)

(21) Appl. No.: 18/190,631

(22) Filed: Mar. 27, 2023

(51) Int. Cl. C07F 9/09; B01J 19/00

(52) U.S. Cl. CPC C07F 9/097; B01J 19/0086; B01J 2219/00033; B01J 2219/00177

(57) ABSTRACT

A highly efficient and safe N-cyanation and N-phosphorylation reagent for the de novo synthesis of pharmaceutically acceptable cyclocreatine and salts was achieved using trichloroacetonitrile in lieu of highly toxic cyanogen bromide (CNBr) for generating the required cyclocreatine (CCr) intermediates, followed by highly effective N-phosphorylation through pH control using phosphoryl chloride with high conversion to the corresponding cyclocreatine phosphate (CCrP) targets. A continuous flow reactor system was engineered to improve the efficiency of the process and deliver a product with improved yield, safety, and cost efficiency.

### FIELD OF THE INVENTION

The present invention relates to a chemical process for synthesizing cyclocreatine (CCr) and cyclocreatine phosphate (1-carboxylmethyl-2-imino-3-phosphono-imidazolidine, CCrP) or pharmaceutically acceptable salt thereof. Furthermore, the present invention relates to development of a continuous flow reactor (CFR) system for synthesizing CCrP or related pharmaceutically acceptable salt.

### BACKGROUND OF THE INVENTION

CCrP and related salts are effective in preventing ischemic injury during cardiac recovery and transplantation. When administered prior to ischemia, CCrP and related salts delay ATP depletion during ischemia and can restore cardiac function in models of hypothermic cardioplegic cardiac arrest (e.g., models of bypass surgery), regional warm ischemia (e.g., models of acute myocardial infarction), and global warm ischemia (e.g., models of cardiac arrest).

CCrP is prepared from cyclocreatine (1-carboxymethyl-2-iminoimidazolidine, CCr) precursor, which is insoluble in water. Thus, a pharmaceutically acceptable salt of CCr has been used for CCrP synthesis to generate pharmaceutically acceptable CCrP salts. Referring to U.S. Pat. No. 7,964,736B2, for which one of the inventors of the present invention is the co-inventor, a lithium salt of CCrP was originally synthesized for pharmaceutical use that showed some side effects in vivo from the lithium at high doses. It is discovered since then that when the lithium salt is replaced by a sodium salt, the prepared CCrP salt is therapeutically effective and does not have side effects.

Referring again to U.S. Pat. No. 7,964,736B2, cyanogen bromide was originally used as N-cyanation reagent for preparing CCr. The cyanogen bromide is highly toxic and is not always available at CCrP manufacturing sites. A more efficient synthetic procedure for increasing CCrP yield and a safer manufacturing environment are needed.

The present invention discloses a commercially viable process for synthesizing CCrP and related salts. The process developments are focused on three aspects: i) engineer a continuous flow reactor (CFR) system to improve product yield and cost efficiency, ii) eliminate the use of highly toxic cyanogen bromide in the synthesis of cyclocreatine (CCr) intermediate precursors, and iii) develop an improved N-phosphorylation process based on an improved de novo synthesis for producing both the CCr intermediates using simple amines, as well as the final CCrP.

One aspect of the present invention is to engineer a CFR system. For manufacturing a product at commercial scale, there are several main drives when it comes to optimizing a process, for example, sustainability, cost, performance, and etc. For a chemical process development, there are two fundamentally different approaches, batch versus flow reactions. There is a keen debate over whether a given reaction or synthesis should be carried out using a flow reactor or a batch reactor. Both the batch and continuous reactor systems utilize a same “chemistry” that is using CCr, POCI₃, and an alkali base as the reactants to synthesize CCrP. However, the processes for generating CCrP would be much different for continuous flow reactor vs. batch reactor. In a batch reactor (BR) system, all the reactants are charged to a single reaction vessel to generate product. In comparison, in a continuous flow reactor (CFR) system, the same reactants are continuously charged into the CFR system with product continuously being discharged downstream. Both systems have their advantages and disadvantages, some of which are listed below.

A batch reactor is predominantly used for small-scale operation, for testing new processes that have not been fully developed, for the manufacture of expensive products, and for processes that are difficult to convert to continuous operations. It offers process versatility without the need for breaking containment and include rather straightforward scalability options.

The batch reactor has the advantage of high conversions that can be obtained by leaving the reactant in the reactor for long periods of time, but it also has the disadvantages of high labor costs per batch, the variability of products from batch to batch, and the difficulty of large-scale production. Quality control can be improved by the production of small batches, which is one of the primary benefits of batch reactors. The process can be trialed in small volume, analyzed, and subsequently modified if required by running a synthesis in a small batch reactor.

In contrast, a continuous flow reactor systems utilize “Flow Chemistry”, a process whereby reactions are carried out in a continuous stream or sequence under a given state of conditions. CFR systems are often developed modular, that is, a variety of flow reactions are carried out, either in series or in parallel fashion, to generate product. Continuous flow reactors are usually microfluidic systems which utilizes tubing and high-pressure pumps to mix reagents together under a predefined set of conditions (heat, catalyst, microwave, etc.) inside a reaction flow cell to generate product on a continuous or sub-continuous basis.

CFR systems continue to excel in chemical processing applications as they can overcome traditional limitations of typical batch reactors, such as high-pressure requirements, suboptimal yields, and excessive material consumption.

The CFR systems provide following features and benefits: reduction in the consumption of material; the ability to rapidly screen reaction conditions; the ability to design and optimize scalable reaction methodology; the ability to directly compare reaction conditions with process efficiency; and improved safety, product stability, and more efficient resource usage including space.

Another aspect of the present invention is to eliminate the use of highly toxic cyanogen bromide in the synthesis of cyclocreatine (CCr) intermediate precursor. CCrP and salts are typically manufactured using CCr precursor in conjunction with a N-cyanation reagent. A frequent method employed to synthesize the intermediate CCr is based on the Rowley method, which uses cyanogen bromide 2a (Scheme 1) as the N-cyanation reagent via electrophilic substitution.

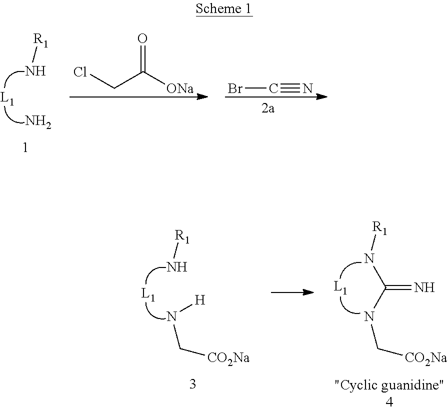

Scheme 2 outlines a method that was originally chosen to synthesize CCr (3a) via cyanogen bromide (2a) and 1,2-diaminoethane (1a) based on the Rowley method. An intermediate sodium salt of the diamine using sodium chloroacetic acid (Scheme 2) was first isolated, followed by electrophilic cyanation of the secondary amine through intramolecular cycloaddition to form the intermediate CCr (3a).

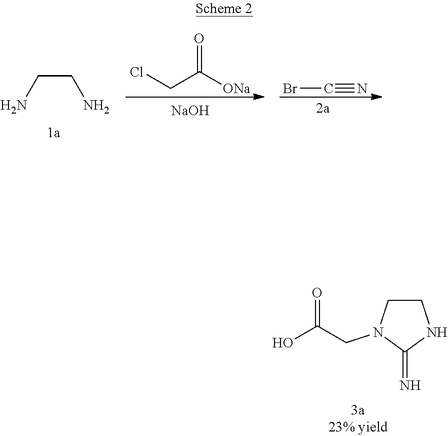

Although cyanogen bromide (2a) was a common and cheap reagent to generate cyanamide precursors, such as CCr (3a), the extreme toxicity associated with its use created major safety and supply chain concerns, in addition to the extremely poor overall yield associated with using the reagent (23%). The poor yield was likely due to the decomposition of cyanogen bromide under the pH conditions required to generate the intermediate cyanamide species.

The second step for preparing CCrP involves N-phosphorylation of CCr (3a) using phosphoryl chloride (5a) under an alkaline condition controlled by a base, such as sodium hydroxide, to generate CCrP 4a (Scheme 3).

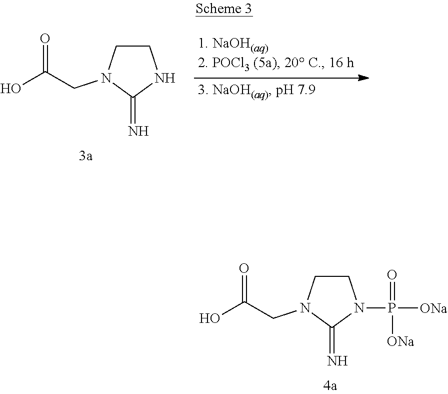

Scheme 3 illustrates an original synthesis of CCrP (4a) using CCr (3a) as a starting material, phosphoryl chloride (5a) as the N-phosphorylation reagent, and aqueous sodium hydroxide solution to adjust pH value of the reaction solution.

Furthermore, another aspect of the present invention is to develop an improved N-phosphorylation process based on an improved de novo synthesis for producing both the CCr intermediates using simple amines, as well as the final CCrP.

Our previous work has demonstrated that CCrP could be synthesized in an aqueous media using a de novo synthesis utilizing phosphoryl chloride 5a (Scheme 3) as the N-phosphorylation reagent. Referring to FIG. 1, there illustrated is ³¹P NMR spectrum of CCrP product prepared by the original synthetic method. As shown in FIG. 1, although the process resulted in the CCrP 4a, the undesirable bis-N-phosphoramidate was found to be present in minor amounts after numerous recrystallizations.

Scheme 4 shows formation mechanism of bis-aminophosphoramidate impurity during the N-phosphorylation process.

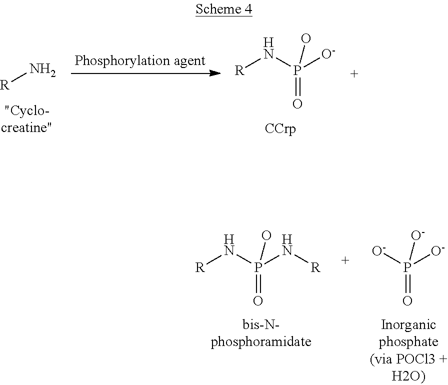

Hodgson et. al. noted the same bis-aminolysis side product as a result of the phosphorylating agent being attacked by two equivalents of amine along with the subsequent inorganic phosphate derived from the breakdown of the phosphorylating reagent (POCl₃).

In addition to this unwanted impurity, the synthetic method for synthesizing the CCr intermediates used the highly toxic reagent cyanogen bromide (2a) to generate the required cyanamide precursor through electrophilic substitution of the diamine. These problems motivated us to find a safe and more efficient synthesis of CCrP in such a manner where product purity, reaction yield, impurity profile, and efficacy are not compromised, building on our previous work in the area.

Previously, utilizing a batch reactor process, the synthesis of CCrP—Na₂ is outlined in Scheme 5, in which phosphoryl chloride is introduced directly to an alkaline solution of CCr followed by pH adjustment.

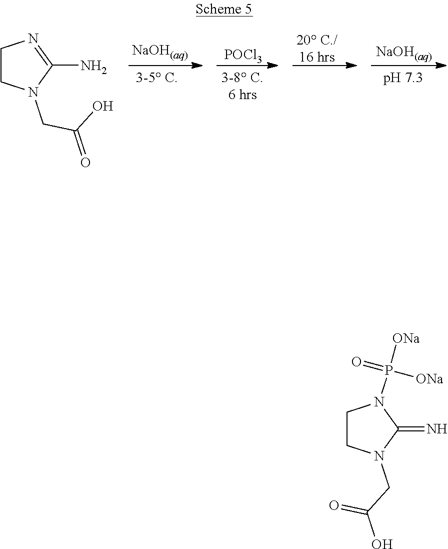

Based on the pharmaceutical efficacy of CCrP and salts previously accomplished in preventing ischemia during myocardial injury, there exists a need to not only eliminate the extreme toxicity issues associated with using cyanogen bromide to generate the necessary CCr intermediates 4 (Scheme 1), as well as to improve upon the subsequent N-phosphorylation conversion of the intermediate cyclocreatine to the final CCrP target.

### SUMMARY

An object of the present invention is to develop a highly efficient and sustainable process for producing CCrP or related pharmaceutically acceptable salt, using a continuous flow reactor (CFR) system. The CFR system comprises at least two flow cells to build a two-stage reaction system which leads to a product of aqueous solution of cyclocreatine phosphate hydrated salt in the form of cyclocreatine phosphate disodium dihydrate (CCrP—Na₂). A subsequent isolation and purification of the CCrP—Na₂ leads to a final product of pure powder.

The process for making CCrP—Na₂ is based on cyclocreatine (CCr) in an aqueous media of formula (III), followed by an aqueous solution of an alkali base, such as sodium hydroxide (NaOH), and subsequently phosphoryl chloride. In the CCr intermediate of formula (III), R1 is H and R2 is CH₂CO₂H or CH₂CO₂Na or CH₂CO₂Y, where Y is a carboxyl protecting group. The aqueous solution of CCr intermediate of formula (III) and the aqueous solution of the alkali base are mixed prior to entering the first flow cell, where phosphoryl chloride is introduced to generate an aqueous solution of CCrP as a Zwitterion complex in the first stage. The aqueous solution of CCrP from the first flow cell is collected in a second flow cell, where a second aqueous solution of the alkali base is injected in a second stage to adjust the pH value of the solution to a specific pH range, which subsequently generates an aqueous solution of cyclocreatine phosphate disodium dihydrate (CCrP—Na₂).

Another object of the present invention is to develop an improved DE NOVO synthetic method for commercial synthesis of CCrP and related salts of formula (IV) in an increased overall yield. The improved method incorporates an alternative DE NOVO reagent to replace highly toxic cyanogen bromide used in the Rowley method of making required CCr intermediate. The improved DE NOVO synthetic method comprises reacting a compound of formula (I) with a compound of formula (II) to generate a CCr intermediate of formula (III) or an acceptable salt thereof. The CCr intermediate (III) is reacted with phosphoryl chloride to yield final product of formula (IV).

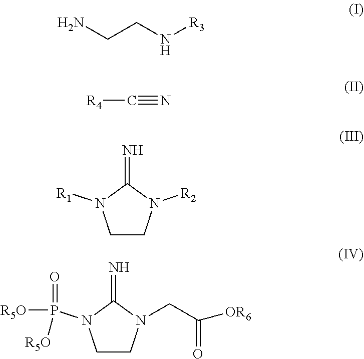

In the above compounds of formula (I), (II), (III), and (IV), R1 is hydrogen; R2 is CH₂CO₂H or CH₂CO₂Y, where Y is Na, K, or a carboxyl protecting group; R3 is CH₂CO₂H or CH₂CO₂Y, where Y is Na, K, or a carboxyl protecting group; R4 is CCl₃; R5 is a mono-valent cation, and R6 is hydrogen or a cation.

Yet, another object of the present invention is to develop an improved DE NOVO synthetic method for synthesizing CCr of formula (III) or a pharmaceutically acceptable salt thereof. In this method, the trichloroacetonitrile is used to replace cyanogen bromide used in Rowley method for synthesizing cyclic guanidine compounds. The synthesized CCr is purified as the final product.

The method comprises reacting a compound of formula (I) with a compound of formula (II) to generate cyclocreatine of formula (III) or an acceptable salt thereof.

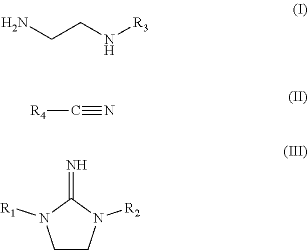

In the above compounds of formula (I), (II), and (III), R₁ is H; R₂ is CH₂CO₂H or CH₂CO₂Y, where Y is Na, K, or a carboxyl protecting group; R₃ is CH₂CO₂H or CH₂CO₂Y, where Y is Na, K, or a carboxyl protecting group; and R₄ is CCl₃.

### BRIEF DESCRIPTION OF THE DRAWINGS

FIG. 1 is a ³¹P NMR spectrum of cyclocreatine phosphate disodium dihydrate (CCrP—Na₂) product prepared in a prior work;

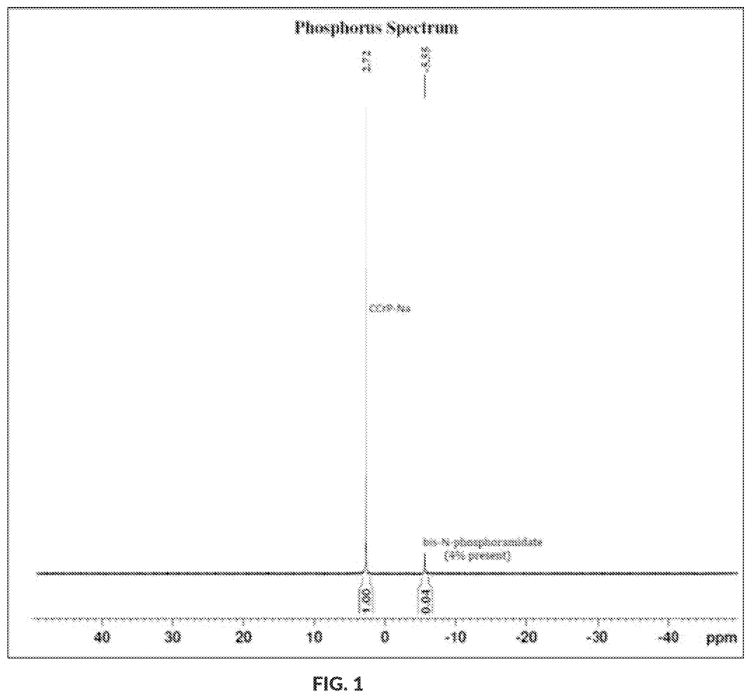

FIG. 2 is a flow diagram of continuous flow reactor (CFR) system for synthesizing CCrP—Na₂ according to one embodiment of the present invention.

### DETAILED PATENT DESCRIPTION

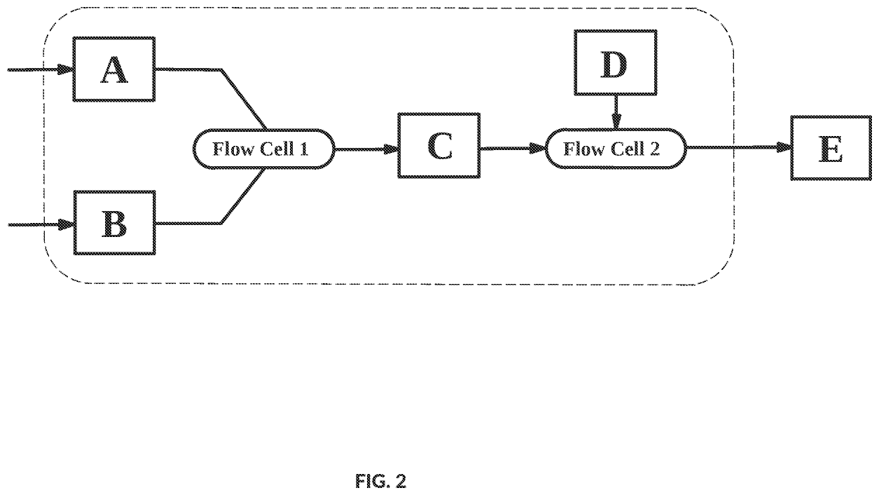

A highly efficient and sustainable method for synthesizing cyclocreatine phosphate (CCrP) from cyclocreatine (CCr) precursor has been developed using a Continuous Flow Reactor (CFR) system. Referring to FIG. 2, there illustrated is a flow diagram of CFR system for CCrP—Na₂ synthesis. This system specifically is a two-stage CFR system which leads to an aqueous solution of CCrP—Na₂ as an output feedstock. The subsequent crystallization of the CCrP—Na₂ yields a final product isolated as a pure powder.

The present invention further describes synthesis of CCrP as a Zwitterion complex in the first stage of the process by reacting cyclocreatine-based precursors and phosphoryl chloride in an aqueous media, followed by the second stage where such intermediate of the Zwitterion complex is converted to a hydrated salt by a reaction with sodium hydroxide to a defined pH range to generate the targeted cyclocreatine phosphate ionic salt.

As shown in FIG. 2, the continuous flow reaction (CFR) system according to an embodiment of the present invention comprises two flow reaction cells, in which two liquid feedstocks (A and B) are combined in the first reaction flow cell 1 to generate a homogeneous solution of the Zwitterion intermediate C. The Zwitterion intermediate C is transported to the second flow cell 2, where the reaction solution is controlled with pH adjustment using an auto titrator D, to generate an aqueous solution of final product E.

The present invention is directed at an improved synthetic method for commercial synthesis of CCrP and salts of formula (IV) in greater overall yield without using the extreme hazards associated with cyanogen bromide (2a) by incorporating an alternative de novo reagent to generate the required cyanamide intermediate, which leads to the formation of the CCr precursor compound of formula (III) in lieu of cyanogen bromide as outlined in Scheme 6.

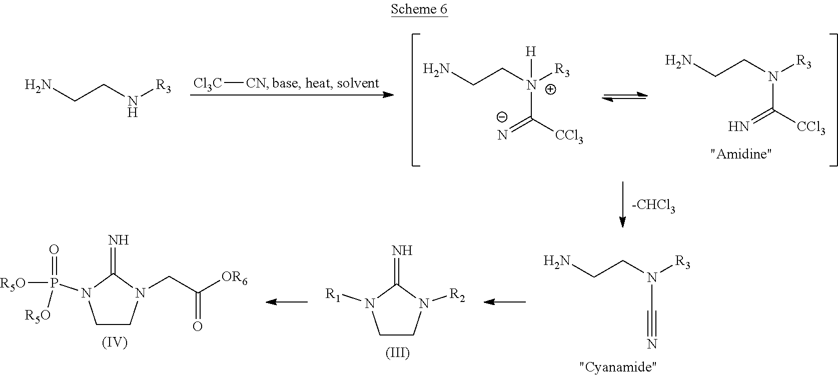

In scheme 6, the trichloroacetonitrile is used to replace cyanogen bromide (2a) used in Scheme 2 to generate CCr intermediates. Specifically, a compound of formula (I):

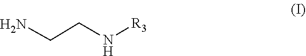

undergoes N-cyanation using a compound of formula (II):

R₄—C≡N (II)

to generate a cyclocreatine intermediate of formula (III):

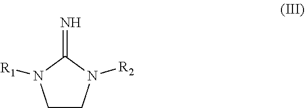

or an acceptable salt thereof, followed by N-phosphorylation using POCl₃ to yield final target of formula (IV):

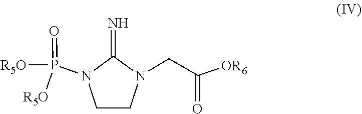

where: R₁ is H; R₂ is CH₂CO₂H or CH₂CO₂Na or CH₂CO₂Y (where Y is a carboxyl protecting group); R₃ is CH₂CO₂H or CH₂CO₂Na or CH₂CO₂Y (where Y is a carboxyl protecting group); R₄ is CCl₃; R₅ is a mono-valent salt (e.g., Na, K, or equivalent); R₆ is H or an acceptable salt.

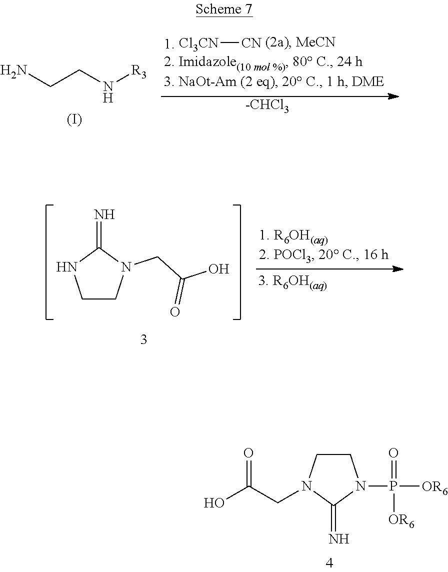

In Scheme 7, an embodiment of the present invention describes a method for the preparation of CCrP through directed N-cyanation of the secondary amine using trichloroacetonitrile in the presence of a base to generate the required CCr intermediate and chloroform after undergoing intramolecular cycloaddition. The crude CCr is then subjected to N-phosphorylation conditions to yield the CCrP (phosphagen) product under pH-controlled mild conditions. In this synthetic method, the CCr intermediate isolated is converted directly to CCrP without having to undergo stringent purification, lending a process which is amendable to large-scale commercial manufacturing with improved safety and efficiency.

As outlined in Scheme 7, according to the embodiment of the present invention, the CCr intermediate is prepared by the following procedure. A reaction vessel equipped with a stirrer is charged with the compound of formula (I) (1 eq.), acetonitrile ([amine]=1 mol mL), trichloroacetonitrile (1.1 eq.), and imidazole (10 mol %). The system is allowed to stir at 75-85° C. until the reaction is completed. The mixture is then concentrated to remove all of the acetonitrile and excess trichloroacetonitrile. The crude intermediate is then dissolved in dimethoxyethane (DME) to form a 0.2 M solution before charging sodium tert-pentoxide (NaOt-Am, 2 eq.) in one portion and stirring for 15-20 minutes at 20° C. Aqueous NaHCO₃ is added, and the product extracted out using ethyl acetate. The organics are then dried over sodium sulfate and concentrated. The crude CCr collected is then dissolved in boiling water, and allowed to cool and chilled to fully precipitate product. Product is then filtered, washed with cold water and dried.

In the case where CCr contains unwanted impurities, CCr is dissolved in a boiling water, filtered, and chilled to precipitate CCr, followed by triturating with cold water and drying to generate pure CCr.

In another embodiment according to the present invention, detailed is a process for the preparation of a compound of formula (IV):

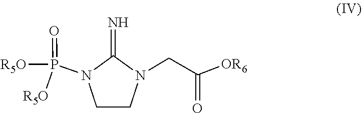

by reacting a compound of formula (I):

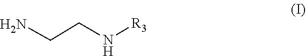

with a compound of formula (II)

R₄—C≡N (II)

to generate an intermediate of formula (III):

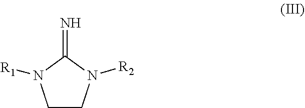

or an acceptable salt thereof, followed by N-phosphorylation to yield final target of formula (IV):

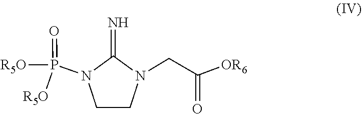

where: R1 is H; R2 is CH₂CO₂H or CH₂CO₂Na or CH₂CO₂Y (where Y is a carboxyl protecting group); R3 is CH₂CO₂H or CH₂CO₂Na or CH₂CO₂Y (where Y is a carboxyl protecting group); R4 is CCl₃; R5 is a mono-valent salt, such as Na, K, or equivalent; R6 is H or a cation forming an acceptable salt with CCrP of formula (IV).

It should be understood that, throughout this patent application, the term “a carboxyl protecting group” refers to a functional group that protects the carboxyl group from being changed, removed, or eliminated from the molecule during preparation of CCr or CCrP. The carboxyl protecting group is a suitable chemical group which may be attached to the carboxyl functionality of a molecule, then removed at a later stage to reveal the intact functional group and molecule. Examples of suitable protecting groups for various functional groups are described in Theodora W. Greene, Peter G. M. Wuts: Protective Groups in Organic Synthesis, 3^{rd} ed. Wiley Interscience, 1999; L. Fieser and M. Fieser, Fieser and Fieser's Reagents for Organic Synthesis, John Wiley and Sons (1994); L. Paquette, ed. Encyclopedia of Reagents for Organic Synthesis, John Wiley and Sons (1995); each of which is incorporated by reference in its entirety.

### EXAMPLES

### Synthesis of Cyclocreatine Phosphate Disodium Dihydrate (CCrP—Na₂)

The synthesis of CCrP—Na₂ was carried out by steps of preparations of Feedstocks 1 and 2, N-Phosphorylation reaction to convert CCr—Na to CCrP—Na₂, and isolation and purification of CCrP—Na₂.

1.1 Preparation of Feedstock 1: De-ionized water (0.3 L, 222 mol) and sodium hydroxide flakes (38.6 g, 0.96 mol, 17 equivalent) were combined and allowed to stir for 5-10 minutes at room temperature, or until a clear solution resulted, at which point 2-imino-1-imidazolidineacetic acid “cyclocreatine” (8.0 g, 56 mmol was charged to the solution all at once and allowed to stir until a clear solution resulted (ca. 10-15 minutes). The concentration of the cyclocreatine sodium salt was 0.91 molar. The feedstock 1 was a clear and colorless solution.

1.2 Preparation of Feedstock 2: Phosphoryl chloride (42 g, 25.6 mL, 273 mmol, 4.9 equivalent) was measured by mass under an inert atmosphere. The concentration of POCl₃ was 10.7 molar as a neat liquid. The feedstock 2 was a clear and colorless liquid.

1.3 N-Phosphorylation reaction to convert CCr—Na to CCrP—Na₂: in reaction flow cell 1, the temperature was set to 35° C. The initiated additions of both feedstocks 1 and 2 to the reaction flow cell 1 were set at the following rates: feedstock 1 feeding rate was 50 mL/min (46 mmol/min) and feedstock 2 feeding rate was 5 mL/min (55 mmol/min) with a resonance time of 10-12 minutes under an inert nitrogen atmosphere. A clear solution was formed as the effluent (output) from the reaction flow cell 1 and collected in the reaction flow cell 2 under an inert atmosphere. The reaction flow cell 2 was assembled with an agitator and an auto titrator filled with 5 N NaOH aqueous solution using DI water. The pH of the effluent was typically between 2.4 and 2.6.

1.4 Isolation and purification of CCrP—Na₂: using the auto titrator, 5 N NaOH solution was added to the reaction flow cell 2 with mild agitation to a targeted pH of 7.58 (7.45 to 7.71) while keeping the reaction temperature between 25 to 38° C. for over 10 minutes. While warm, the mixture remained a clear and colorless solution. However, once it was cooled to room temperature (19-20° C.) a cloudy white mixture would form. After adjusting the pH, the temperature was lowered to 5-7° C. and maintained with mild stirring for 30 minutes. The reaction mixture was then filtered through fluted filter paper to remove insoluble. A clear and colorless filtrate resulted. Upon concentrating to dryness (1-2 mmHg, 50-60° C.), a white free flowing powder resulted. DI water (250 mL) was charged to the white solid at room temperature and allowed to stir for 10-15 minutes (longer times are acceptable). Approximately 90-95% of the solid dissolved, leaving white insoluble material which was filtered away using fluted filter paper. The filtrate was concentrated back down to a white solid using vacuum (1-2 mmHg) and 50° C. DI water (250 mL) was charged to the solid and allowed to stir at room temperature (20-25° C.) for 10-15 minutes, followed by filtration to yield CCrP—Na₂ as a clear solution in water.

Hysol (denatured ethanol (EtOH) w/ethyl acetate (EtOAc)) was charged (10× volume, ca. 1.5 L) to the clear and colorless CCrP-water solution with moderate agitation at room temperature (20° C.) over 20 minutes. Agitation was then slowed, and the temperature was adjusted to 5-7° C. and maintained for 16 hours to allow full precipitation of CCrP—Na₂. Product was filtered off easily as a white crystalline solid with a clear and colorless filtrate. The product cake was then triturated with a cold (10-15° C.) 11% ethanol-water solution to remove residual water and impurities. Product was allowed to dry in a 40° C. oven overnight under 1-mmHg vacuum, yielding a white free flowing crystalline powder. (snow white in appearance). Material was extremely soluble in D₂O for ¹H NMR analysis purposes. The product (disodium salt) was very soluble in water. Theoretical yield was 16.94 gram and the actual yield was 12.8 gram.

What is claimed is:

1. A process for synthesizing a compound of formula (IV) or a pharmaceutically acceptable salt thereof, wherein R5 is a mono-valent cation and R6 is H or a cation, using a continuous flow reactor (CFR) system including at least two flow cells, the method comprising: 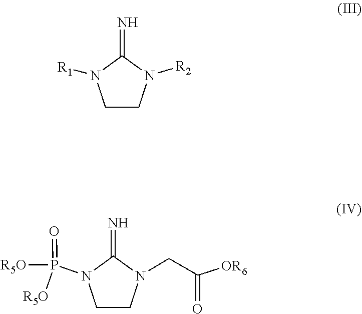
providing an aqueous solution of cyclocreatine intermediate of formula (III), wherein R1 is H and R2 is CH₂CO₂H or CH₂CO₂Na or CH₂CO₂Y, the Y being a carboxyl protecting group;
providing a first aqueous solution of a base;
providing phosphoryl chloride;
mixing the aqueous solution of cyclocreatine intermediate of formula (III), the first aqueous solution of the base, and the phosphoryl chloride in a first flow cell to generate an aqueous solution of cyclocreatine phosphate as a Zwitterion complex in a first stage;
collecting the aqueous solution of cyclocreatine phosphate in a second flow cell; and
injecting a second aqueous solution of the base to the second flow cell in a second stage so as to control pH value and to generate an aqueous solution of cyclocreatine phosphate disodium dihydrate (CCrP—Na₂).

2. The process of claim 1 further comprising mixing the aqueous solution of cyclocreatine intermediate of formula (III) and the first aqueous solution of the base to form a first feedstock, and mixing the first feedstock with the phosphoryl chloride in the first flow cell to generate the aqueous solution of cyclocreatine phosphate as a Zwitterion complex in the first stage.

3. The process of claim 1, wherein the pH value in the second flow cell is controlled in a range between 7.45 and 7.71.

4. The process of claim 1, wherein the base is selected from a group including NaOH, KOH, Na₂CO₃, K₂CO₃, NaHCO₃, KHCO₃, and a combination thereof.

5. The process of claim 1, each of R5 and R6 cations, independent of each other, is selected from a group including Na and K.

6. The process of claim 1, wherein the pharmaceutical acceptable salt of the compound of formula (IV) is in a hydrated form including cyclocreatine phosphate disodium dihydrate.

7. A method for synthesizing a compound of formula (IV) or a pharmaceutically acceptable salt thereof, 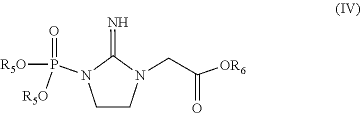
the method comprising:
reacting a compound of formula (I): 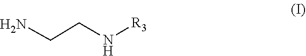
with a compound of formula (II)
R₄—C≡N (II)
to generate an intermediate of formula (III): 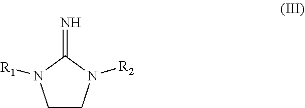
or an acceptable salt thereof, and
reacting the intermediate of formula (III) with phosphoryl chloride by N-phosphorylation to yield final product of formula (IV): 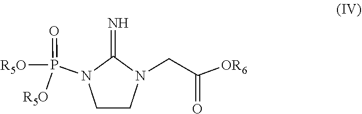
wherein:
R1 is H,
R2 is CH₂CO₂H or CH₂CO₂Y, wherein Y is Na, K, or a carboxyl protecting group,
R3 is CH₂CO₂H or CH₂CO₂Y, wherein Y is Na, K, or a carboxyl protecting group,
R4 is CCl₃,
R5 is a mono-valent cation, and
R6 is H or a cation.

8. The method of claim 7, wherein each of R2 and R3, independent of each other, is CH₂CO₂CH₂C₆H₅.

9. The method of claim 7, wherein each of R5 and R6 cations, independent of each other, is selected from a group including Na, K, and a combination thereof.

10. A method for synthesizing cyclocreatine of formula (III) or a pharmaceutically acceptable salt thereof, the method comprising: 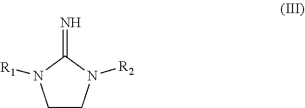
reacting a compound of formula (I): 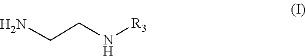
with a compound of formula (II)
R₄—C≡N (II)
to generate cyclocreatine of formula (III) or an acceptable salt thereof, 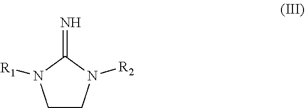
wherein:
R1 is H,
R2 is CH₂CO₂H or CH₂CO₂Y, wherein Y is Na, K, or a carboxyl protecting group,
R3 is CH₂CO₂H or CH₂CO₂Y, wherein Y is Na, K, or a carboxyl protecting group, and
R4 is CCl₃.

11. The method of claim 10, wherein each of R2 and R3, independent of each other, is CH₂CO₂CH₂C₆H₅.
